(19) United States
(12) Patent Application Publication
(10) Pub. No.: US 2015/0040761 A1
(43) Pub. Date: Feb. 12, 2015

(54) HYDROCYCLONE WITH FINE MATERIAL REDUCTION IN THE CYCLONE UNDERFLOW

(71) Applicant: ANDRITZ ENERGY & ENVIRONMENT GMBH, Raaba (AT)

(72) Inventor: Michael Kramer, Graz (AT)

(21) Appl. No.: 14/377,423

(22) PCT Filed: Feb. 8, 2013
(86) PCT No.: PCT/EP2013/000380

§ 371 Date: Aug. 7, 2014

(30) Foreign Application Priority Data
Feb. 10, 2012 (AT) A 177/2012

(51) Int. Cl. B04C 5/04; B01D 47/06; B01D 45/16

(52) U.S. Cl. CPC B04C 5/04; B01D 45/16; B01D 47/06
USPC 95/219; 55/459.4; 95/271; 96/321

(57) ABSTRACT

A hydrocyclone including an inflow region with a tangential inlet for a feed slurry and having a separating region which adjoins the inflow region and which has an underflow nozzle for discharging coarse materials or coarse granules. At least one additional inlet for feeding a blocking fluid flow is provided in the region of the tangential inlet, the blocking fluid flow and the feed slurry being separated from each other by a lamella at least in the upper region of the hydrocyclone. A method for operating the hydrocyclone is also disclosed.

The subject of this invention is a hydrocyclone having an inflow region which has a tangential inflow for the feed slurry, and with a separation region following the inflow region and having an underflow nozzle for the discharge of heavy materials, coarse materials or coarse grain. The subject of this invention is also a method for operating the hydrocyclone according to the invention.

Hydrocyclones are centrifugal separators for suspensions or mixtures. By means of these, mostly solid particles are separated or graded. Emulsions, such as, for example, oil/water mixtures, can likewise be separated thereby.

The hydrocyclone is an important component of gypsum dewatering in a wet flue gas purification plant. In this case, the suspension drawn off from the absorber is partially dewatered by one or more hydrocyclones and subsequently passes onto a band filter or into a centrifuge. As a result of this method, the gypsum is brought to a residual moisture of mostly less than 10% and can then be transported away.

Conventional hydrocyclones are usually composed of a cylindrical segment with a tangential inflow (inflow nozzle) and with an adjoining conical segment having the underflow nozzle or apex nozzle. The vortex finder or overflow nozzle projects axially from above in the form of an immersion tube into the interior of the cyclone.

In the present invention, overflow or top flow is understood to mean the specifically lighter and/or smaller-grained fraction and underflow can mean the specifically heavier and/or coarser fraction.

In the present invention, the overflow does not necessarily have to leave the hydrocyclone “at the top” or in the inflow region. Exemplary embodiments may also be envisaged in which the hydrocyclone operates on the cocurrent principle, that is to say in which the underflow and overflow leave the hydrocyclone in the same direction.

In the present description, the designations “top” and “bottom” are linked to the inflow and to the underflow. However, the actual position of the hydrocyclone is to the greatest possible extent independent of this, thus even horizontally installed hydrocyclones are often used.

In hydrocyclones on the countercurrent principle, the liquid is forced through the tangential inflow into the cylindrical segment along a circular path and flows downward in a downwardly-directed vortex. The taper in the conical segment results in acceleration and an inward displacement of volume and in a build-up in the lower region of the cone. This leads to the formation of an inner upwardly directed vortex which is discharged through the overflow nozzle. The aim is the separation of the specifically heavier fraction (for example, solids, coarse material, coarse grain) on the wall of the cyclone and therefore discharge through the underflow nozzle, whereas the specifically lighter or finer-grained fraction escapes through the overflow nozzle.

The fundamental principle of the separating and grading effect is described by the interaction of the centrifugal forces and flow forces. Whereas the centrifugal force acts to a greater extent upon large specifically heavy particles (coarse materials) and these are therefore separated outwardly to the cyclone wall, in the case of small lightweight particles, because of their higher specific surface, the force of the flow upon the particles (resistance force) is of major importance.

In conventional hydrocyclones, the uniform dispersion of fine materials in the inflow ensures a division of these grain size classes according to the division of the volumetric flow rate between the overflow and underflow. This means that fine materials are normally separated out with the coarse materials in the fraction corresponding to the underflow/inflow volume split (volumetric flow ratio).

Conventional hydrocyclones therefore usually do not manage to reduce from the underflow a disperse phase, the density of which is similar to that of the fluid or the particle size of which is small (<5 μm).

Recent developments, such as are described, for example, in DE102009057079A, go a step further in that, by inducing a washing flow from a pure fluid, they attempt to separate fine fractions out of the underflow. The washing water stream is in this case usually introduced tangentially in the cone or in the lower region of the cyclone. A result of this dilution is that the fine material concentration in the coarse material discharge, that is to say in the underflow, is reduced. The disadvantage in this case is that the liquid introduced and the accompanying turbulence cause already separated heavy fractions to be flushed into the core flow again. This reduces the purity of the overflow. On account of these disadvantages, the reduction of the fine materials in the underflow can be implemented only to a limited extent, mostly only to the extent corresponding to the water stream additionally introduced. EP 1 069 234 B1 discloses the addition of the diluting liquid directly into the core flow through an inflow tube arranged centrally in the apex nozzle.

The object on which the invention is based is, therefore, to provide a hydrocyclone which improves separation in such a way that the faulty discharge of both fine material or fine grain in the underflow and of coarse material or coarse grain in the overflow is decreased. The fine materials are therefore to be reduced in the underflow with respect to the volume-related concentration in the inflow.

This object is achieved by means of a hydrocyclone in which, by a barrier layer of water or of another fluid being introduced, a pure phase is made available, through which the coarse material has to settle, whereas the fine fraction predominantly remains behind in the original stream. The supply of this barrier fluid takes place through at least one further inflow independent of the suspension supply. The barrier fluid stream is separated from the suspension or feed slurry by a lamella and can be introduced in the cylindrical segment. The lamella in this case assumes the task of preventing intermixings in the inlet region and of allowing contact of the flow layers only after a stable profile has been formed.

The supply of a barrier layer in the cone region may also be envisaged, in which case a stepped widening of the cyclone diameter may be provided, so that the barrier water stream can be introduced without any displacement of the suspension. The hydrocyclone wall in this case also at the same time forms the lamella.

The fundamental idea of the invention is to obtain sedimentation conditions as defined as possible by the formation of a sedimentation auxiliary layer (barrier fluid flow), which is in no interaction or in only insignificant interaction with the main flow, in order to achieve genuine particle separation over the sedimentation path thereof, and without any enrichment, as is otherwise customary.

The fine fractions (fine materials) remain for the predominant part in the core flow. The barrier fluid flow in this case surrounds the feed slurry in the form of a ring. The fine materials or the fine grain are therefore reduced in the underflow or are ideally separated entirely, with respect to the volume-related concentration in the inflow (even taking into account the administered barrier fluid quantity or barrier water quantity). The barrier fluid stream can preferably be supplied tangentially to the inflow region via the at least one further inflow. A stable circular barrier fluid flow can thereby be formed inside the cyclone.

Preferably, the lamella is of essentially cylindrical or conical form. It may in this case extend, in the inflow region or in the cylindrical segment, from the inflow region of the barrier fluid flow as far as the transition to the separation region or conical segment or may be fastened in the conical region. Sufficient time therefore remains to enable a stable circular flow to form both in the barrier fluid layer and in the feed slurry.

It is beneficial if the lamella tapers to a point at its lower end or is made as thin as possible, so that the barrier fluid stream and the feed slurry can be combined so as to be as vortex-free as possible. The two flows should also flow further on, as far as possible separated from one another, underneath the lamella.

In a beneficial embodiment of the invention, there is arranged downstream of the lamella, as seen in the direction of flow of the feed slurry, a flow separator, by means of which the combined barrier fluid stream and the feed slurry are separated from one another again. Subsequent intermixing of the already separated layers can be reduced or prevented by means of the flow separator.

Preferably, the distance between the lamella and the flow separator is adjustable. The separating grain size can thereby be influenced.

The use of a flow separator makes it possible to have an embodiment of the hydrocyclone in which the barrier fluid stream forms the underflow, that is to say the fraction enriched with the heavy or coarse materials, and in which the feed slurry depleted of heavy materials forms the overflow. In this case, it is also conceivable that the underflow and the overflow are discharged out of the hydrocyclone downward. In this embodiment, therefore, the hydrocyclone would operate on the cocurrent principle.

In this case, it is beneficial if the hydrocyclone has essentially a cylindrical set-up.

The lamella may also have compensating orifices which make a connection between the feed slurry and the barrier fluid flow, thus resulting in pressure compensation between the barrier fluid and suspension before the two layers meet one another.

Ideally, in this case, the barrier fluid is always acted upon by a somewhat higher pressure than the suspension.

It is also conceivable that additional washing or diluting water can be introduced in the underflow region, so that further reduction of fine materials or fine grain in the underflow can thereby be achieved. For example, in the region of the apex, a water stream may be supplied axially to the vortex in order to minimize reswirling or full mixing of the separated layers.

The subject of the invention is also a method for operating the hydrocyclone according to the invention, the barrier fluid stream and the feed slurry being led further on together in the hydrocyclone as soon as the barrier fluid flows and the feed slurry flow have become stable.

It is in this case conceivable that the barrier fluid flow and the feed slurry flow, after being combined, are separated again by means of a flow separator.

In such an embodiment, the two separated flows can be discharged out of the hydrocyclone downward. The underflow and the overflow therefore leave the hydrocyclone in the same direction.

Preferably, washing or diluting water is injected in the region of the underflow nozzle, for example via an inflow tube arranged centrally in the underflow nozzle.

The hydrocyclone according to the invention is described below by means of four drawings in which:

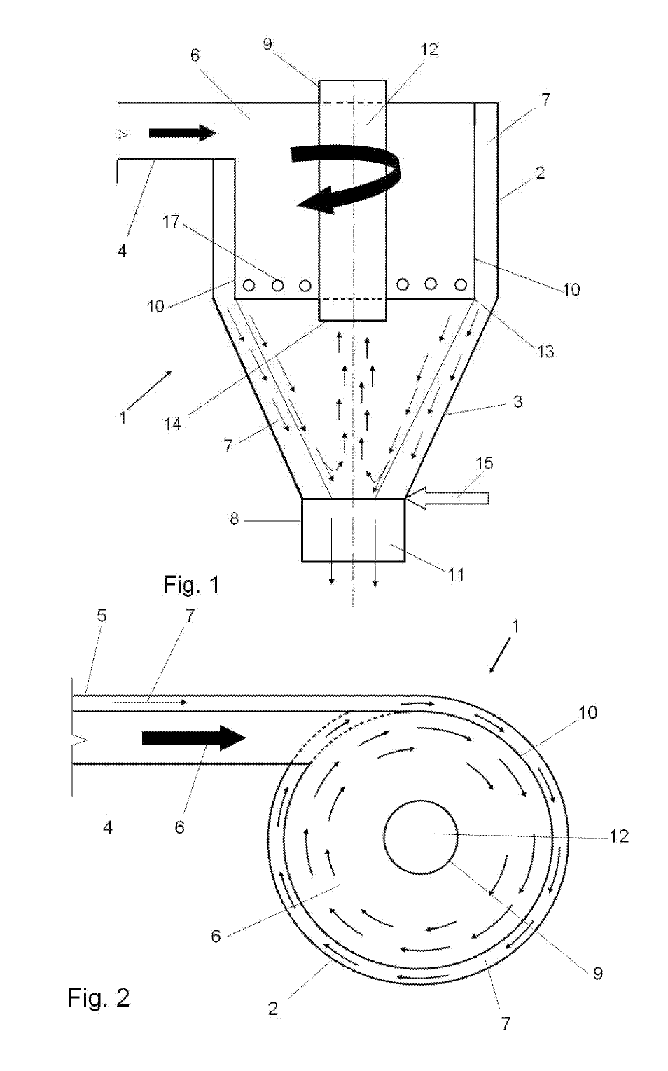

FIG. 1 shows a diagrammatic longitudinal section through an exemplary embodiment of the hydrocyclone according to the invention;

FIG. 2 shows a cross section in the region of the inflow through the hydrocyclone according to the invention;

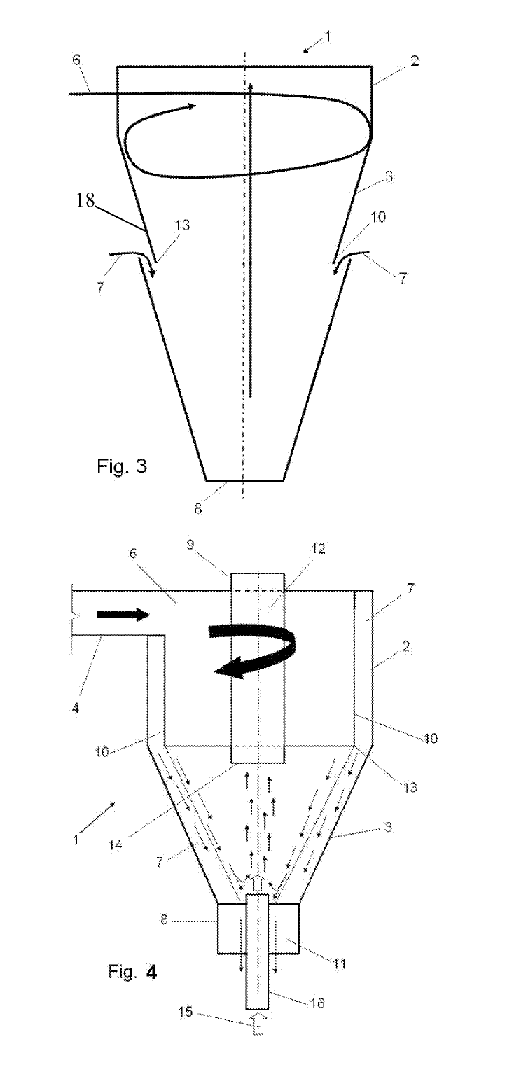

FIGS. 3 and 4 show a diagrammatic longitudinal section through further exemplary embodiments of the hydrocyclone according to the invention;

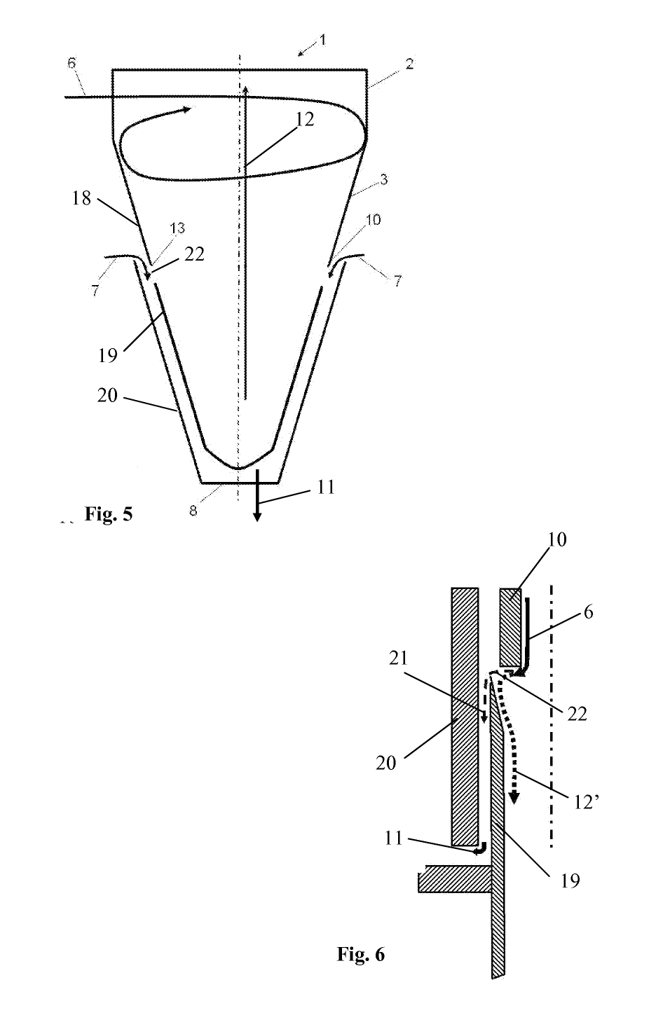

FIG. 5 shows a diagrammatic longitudinal section through an exemplary embodiment of the hydrocyclone according to the invention with a flow separator;

FIG. 6 shows a detail of a hydrocyclone with a flow separator.

The same reference symbols in the individual figures designate in each case the same components.

A hydrocyclone with a cylindrical inflow region and with a conical separation region is dealt with below by way of example. However, the principle according to the invention can also be applied to centrifuges or cyclones which are purely cylindrical, as illustrated in FIG. 6, or are purely conical.

The hydrocyclone 1 according to the invention is illustrated in FIG. 1. It is composed of an inflow region 2 and of a separation region 3 adjoining the latter. Here, the inflow region 2 is of cylindrical form and the separation region 3 of conical form.

A feed slurry 6 is supplied to the hydrocyclone 1 via the tangential inflow 4. The feed slurry 6 may be, for example, a gypsum suspension.

The separation region 3 has an underflow nozzle 8 for the discharge of coarse materials or coarse grain. The specifically lighter or finer-grained fraction can be discharged as overflow 12 through the overflow nozzle 9 which projects axially in the form of an immersion tube into the interior of the hydrocyclone 1.

In addition to the tangential inflow 4, the hydrocyclone 1 also has a further inflow 5 (illustrated in FIG. 2) for the barrier fluid stream 7 which is supplied to the inflow region 2 here likewise tangentially. The barrier fluid 7 is, for example, water, alcohol or oil. The barrier fluid stream 7 and the feed slurry 6 are supplied separated to the hydrocyclone 1 and are separated from one another by the lamella 10. The lamella 10 is, for example, a cylindrical thin-walled component made of metal. The pure barrier fluid flow 7 meets the actual suspension flow (feed slurry 6) at the lower end 13 of the lamella 10. This occurs as soon as the flows of the barrier fluid 7 and of the feed slurry 6 are of stable form.

After the two volumetric flows 6, 7 have been combined, a settling movement of heavy fractions (coarse materials) through the barrier layer 7 commences. This results in a reduction of the fine materials in the underflow 11. Flow routing in the conical separation region 3 takes place as in conventional hydrocyclones.

The lamella 10 has here compensating orifices 17 which make a connection between the feed slurry 6 and the barrier fluid flow 7, this resulting in pressure compensation between the barrier fluid 7 and suspension 6. These compensating holes may also be envisaged in the region of the inflow 5.

The flow arrows indicate that the barrier fluid flow 7 and the feed slurry 6 are intermixed with one another as little as possible. The barrier fluid flow 7 thus forms with respect to the wall of the conical separation region 3 a barrier fluid layer 7.

Optionally, washing or diluting water 15 may additionally be introduced in the separation region 3 or in the underflow region, and the volume-related fraction of fine materials in the underflow 11 can thereby be further reduced.

The mouth orifice 14 of the overflow nozzle 9 ends here in the region underneath the end 13 of the lamella 10. Depending on the respective volume fractions in the barrier fluid flow 7 and in the feed slurry 6, the separation of the heavy fraction (coarse materials) will be more or less sharply defined.

FIG. 2 illustrates a cross section through a hydrocyclone 1 according to the invention in the region of the inflow. What can be seen clearly here are the tangential inflow 4 for the feed slurry 6 and the tangential inflow 5 for the barrier fluid layer 7. These two inflows 4, 5 issue into the inflow region 2 here essentially in parallel.

FIG. 3 illustrates a further exemplary embodiment of the hydrocyclone 1. The conical separation region 3 of the hydrocyclone 1 has a stepped widening through which the barrier fluid 7 is administered. The feed slurry 6 and the barrier fluid 7 are in this case separated from one another by the lamella 10 which here at the same time constitutes part of the cyclone housing 18. The lamella 10 is formed conically here. The barrier fluid stream 7 is supplied tangentially to the hydrocyclone 1.

FIG. 4 shows a hydrocyclone 1 in which additional washing or diluting water 15 is administered via an inflow tube 16 projecting into the underflow nozzle 8. The inflow tube 16 is arranged centrally in the underflow nozzle 8.

FIG. 5 shows a further exemplary embodiment of the hydrocyclone 1 according to the invention. In this case, a flow separator 19 is arranged underneath the lamella 10. The lamella 10 is formed here by the hydrocyclone wall 18, but it may also be designed as a separate component. The barrier fluid stream 7 is separated from the feed slurry 6 again by the flow separator 19, thus preventing coarse material, which has settled into the barrier fluid stream 7 through the sedimentation gap 22, from flowing back into the feed slurry 6 again. The barrier fluid flow 7 enriched with coarse materials flows between the flow separator 19 and outer wall 20 downward out of the hydrocyclone 1 and thus forms the underflow 11. The feed slurry 6 depleted of coarse materials flows as overflow 12 upward out of the hydrocyclone 1. The sedimentation gap 22 is preferably adjustable, so that the separating grain size can thereby be influenced.

FIG. 6 illustrates the lamella 10, the sedimentation gap 22 and the flow separator 19 of a further exemplary embodiment of a hydrocyclone 1 with a flow separator 19. This hydrocyclone 1 operates on the cocurrent principle. The feed slurry 6 depleted of coarse materials 21, that is to say the overflow 12′, in this case leaves the hydrocyclone 1 downward, in the same way as the underflow 11 enriched with coarse materials 21. This hydrocyclone 1, operating on the cocurrent principle (the overflow 12′ and underflow 11 are drawn off in the same direction), preferably has a cylindrical set-up, since this affords flow-related advantages.

The embodiments illustrated in the drawings constitute merely a preferred version of the invention. The invention also embraces other embodiments in which, for example, a plurality of further inflows 5 are provided for the barrier fluid stream 7. In such hydrocyclones, the barrier fluid would then be administered in a plurality of steps.

1. A hydrocyclone (1) with an inflow region (2) having a tangential inflow (4) for a feed slurry (6) and with a further separation region (3) following the inflow region (2) and having an underflow nozzle (8) for the discharge of heavy materials or coarse grain, characterized in that a further inflow (5) for the supply of a barrier fluid stream (7) is provided, the barrier fluid (7) and the feed slurry (6) being combinable into the hydrocyclone (1), and in that, before being combined, they are separated from one another by a lamella (10).

2. The hydrocyclone (1) as claimed in claim 1, characterized in that the barrier fluid stream (7) can be supplied tangentially to the inflow region (2) via the at least one further inflow (5) .

3. The hydrocyclone (1) as claimed in claim 1, characterized in that the inflow (5) supplies the barrier fluid stream (7) tangentially to the separation region (3), a stepped widening in the hydrocyclone (1) being provided at the combination point, so that the hydrocyclone wall (18) forms the lamella (10).

4. The hydrocyclone (1) as claimed in one of claims 1 to 3, characterized in that the lamella (10) extends into the separation region (3).

5. The hydrocyclone (1) as claimed in one of claims 1 to 4, characterized in that there is arranged after the lamella (10), as seen in the direction of flow of the feed slurry (6), a flow separator (19), by means of which the combined barrier fluid stream (7) and the feed slurry (6) are separated from one another again.

6. The hydrocyclone (1) as claimed in claim 5, characterized in that the distance between the lamella (10) and the flow separator (19) is adjustable.

7. The hydrocyclone (1) as claimed in one of claims 1 to 6, characterized in that the barrier fluid stream (7) forms the underflow (11), and in that the feed slurry (6) depleted of heavy materials forms the overflow (12, 12′).

8. The hydrocyclone (1) as claimed in claim 7, characterized in that the underflow (11) and the overflow (12′) are discharged out of the hydrocyclone (1) downward.

9. The hydrocyclone (1) as claimed in claim 8, characterized in that the hydrocyclone (1) has essentially a cylindrical set-up.

10. The hydrocyclone (1) as claimed in one of claims 1 to 9, characterized in that additional washing or diluting water (15) can be introduced in the separation region (3) or in the underflow region.

11. The hydrocyclone (1) as claimed in claim 10, characterized in that the additional washing or diluting water (15) can be supplied via an inflow tube (16) projecting into the underflow nozzle (8).

12. A method for operating a hydrocyclone (1) as claimed in one of claims 1 to 12, characterized in that the barrier fluid stream (7) and the feed slurry (6) are led further on together in the hydrocyclone (1) as soon as the barrier fluid flow (7) and feed slurry flow (6) have become stable.

13. The method for operating a hydrocyclone (1) as claimed in claim 12, characterized in that the barrier fluid flow (7) and the feed slurry flow (6), after being combined, are separated again by means of a flow separator (19).

14. The method for operating a hydrocyclone (1) as claimed in claim 13, characterized in that the two separated flows (11, 12′) are discharged out of the hydrocyclone (1) downward.

15. The method for operating a hydrocyclone (1) as claimed in one of claims 12 to 14, characterized in that washing or diluting water (15) is injected in the underflow nozzle (8).
